(19) United States
(12) Patent Application Publication
(10) Pub. No.: US 2024/0166888 A1
(43) Pub. Date: May 23, 2024

(54) PAINT ADDITIVE, PAINT COMPOSITION, AND COATING LAYER

(71) Applicant: SHIN-ETSU CHEMICAL CO., LTD., Tokyo (JP)

(72) Inventor: Tomoyuki GOTO, Annaka-shi (JP)

(73) Assignee: SHIN-ETSU CHEMICAL CO., LTD., Tokyo (JP)

(21) Appl. No.: 17/768,647

(22) PCT Filed: Aug. 27, 2020
(86) PCT No.: PCT/JP2020/032426

§ 371 Date: Jan. 17, 2024

(30) Foreign Application Priority Data
Oct. 29, 2019 (JP) 2019-196466

(51) Int. Cl. C09D 5/16; C08G 77/46; C09D 7/65

(52) U.S. Cl. CPC C09D 5/1687; C08G 77/46; C09D 5/1637; C09D 7/65; C08G 2150/00

(57) ABSTRACT

The present invention is a paint additive containing a siloxane-branched polyether-modified silicone shown by an average composition formula (1) R¹ₐR²_{b}R³_{c}SiO_{(4-a-b-c)/2} and having a weight-average molecular weight in a range of 500 to 100,000. In the formula (1), R¹ represents an alkyl group, an aryl group, an aralkyl group, or an organic group shown by a general formula (2) —CₘH₂ₘ—O—(C₂H₄O)_{d}(C₃H₆O)ₑR⁴. R² represents a group shown by a general formula (3) —CₘH₂ₘ—O—(C₂H₄O)_{f}(C₃H₆O)_{g}—R⁵; each R³ represents an organosiloxane shown by the following general formula (4). R⁴ represents a hydrocarbon group, or an organic group shown by R⁶—(CO)—. R⁵ represents a hydrogen atom, a hydrocarbon group, or an organic group shown by R⁶—(CO)—. R⁶ represents a hydrocarbon group. Thus, the present invention provides a paint additive and a paint composition with small environmental load and imparting excellent antifouling performance.

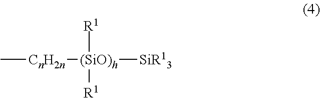

### TECHNICAL FIELD

The present invention relates to: a paint additive containing a siloxane-branched polyether-modified silicone; a paint composition containing the paint additive; and a coating layer; and, in further detail, a paint composition and a coating layer with antifouling performance.

### BACKGROUND ART

In recent years, coatings with paints are performed so as to prevent dirt in various uses including: electric appliances, such as portable telephones, personal computers, televisions, and plasma displays; transportation equipment, such as motor vehicles and trains; and further various everyday necessities.

As a paint with excellent antifouling property, generally, a composition using an additive which contains fluorine in a molecule (Patent Document 1) is known. However, because the material is expensive, and from the standpoint of environmental issues, fluorine-free additives are required.

As a fluorine-free paint additive, a polyether-modified silicone is widely used as paint additive for reasons of surface leveling property, defoaming property, etc. (Patent Document 2). However, a polyether-modified silicone imparting excellent antifouling performance is not known.

On the other hand, as a polyether-modified silicone for enhancing an emulsifying property for cosmetics, a siloxane-branched polyether-modified silicone produced by addition reaction of a polyoxyalkylene compound and a silicone compound to an organohydrogenpolysiloxane is known (Patent Document 3). However, the document does not disclose applications for paints at all.

### CITATION LIST

### Patent Literature

Patent Document 1: JP 2018-070683 A
Patent Document 2: JP 2013-166830 A
Patent Document 3: JP 2001-039819 A

### SUMMARY OF INVENTION

### Technical Problem

The present invention has been made in view of the circumstance. An object of the present invention is to provide: a paint additive and a paint composition with small environmental load and imparting excellent antifouling performance.

### Solution to Problem

To achieve the object, the present invention provides a paint additive comprising a siloxane-branched polyether-modified silicone shown by an average composition formula (1) R¹ₐR²_{b}R³_{c}SiO_{(4-a-b-c)/2} and having a weight-average molecular weight in a range of 500 to 100,000,

wherein in the formula (1) each R is identical to or different from one another and represents an organic group selected from an alkyl group, an aryl group, and an aralkyl group having 1 to 30 carbon atoms, and an organic group shown by a general formula (2) —CₘH₂ₘ—O—(C₂H₄O)_{d}(C₃H₆O)ₑR⁴;
each R² represents a group shown by a general formula (3) —CₘH₂ₘ—O—(C₂H₄O)_{f}(C₃H₆O)_{g}—R⁵;
each R³ represents an organosiloxane shown by the following general formula (4)

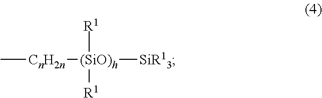

R⁴ represents a hydrocarbon group having 4 to 30 carbon atoms, or an organic group shown by R⁶—(CO)—;
R⁵ represents a hydrogen atom, a hydrocarbon group having 1 to 30 carbon atoms, or an organic group shown by R⁶—(CO)—;
R⁶ represents a hydrocarbon group having 1 to 30 carbon atoms;
R¹ in the general formula (4) is the same as R¹ in the formula (1);
“a”, “b”, and “c” respectively satisfy 1.0≤a≤2.5, 0.001≤b≤1.5, and 0.001≤c≤1.5;
“d” and “e” respectively represent integers satisfying 0≤d≤50 and 0≤e≤50;
“f” and “g” respectively represent integers satisfying 2≤f≤200, 0≤g≤200, and f+g being 3 to 200;
“m” represents an integer satisfying 0≤m≤10;
“h” represents an integer satisfying 0≤h≤500; and
“n” represents an integer satisfying 1≤n≤5.

Such a paint additive can have little environmental load and impart excellent antifouling performance.

Moreover, the paint additive preferably further comprises a solvent.

Such a paint additive can have more excellent workability.

Further, the present invention provides a paint composition comprising the paint additive.

Such a paint composition containing the paint additive successfully reduces environmental load and imparts excellent antifouling performance.

Furthermore, the inventive paint composition preferably comprises a resin selected from the group consisting of urethane resins, acrylic resins, amide resins, phenolic resins, epoxy resins, melamine resins, urea resins, alkyd resins, polyimide resins, polyalkylene resins, polyvinyl chloride, polystyrene, polyvinyl acetate, and alloys of the resins.

Such various resins can be employed in the inventive paint composition.

In this case, the resin is preferably a urethane resin or an acrylic resin.

These resins are preferable because of good compatibility with the paint additive containing the siloxane-branched polyether-modified silicone.

In addition, the inventive paint composition is preferably used for antifouling paint.

The inventive paint composition can exhibit excellent antifouling property without impairing various paint properties, such as defoaming property and leveling property.

Further, the present invention provides a coating layer formed from the paint composition.

The inventive coating layer can be applied to various base materials, and exhibit excellent antifouling property.

### Advantageous Effects of Invention

The use of the inventive paint additive containing the siloxane-branched polyether-modified silicone makes it possible to provide the paint composition and coating layer with small environmental load and excellent antifouling property.

### DESCRIPTION OF EMBODIMENTS

As described above, there have been demands for the development of a paint additive and a paint composition with small environmental load and imparting excellent antifouling performance.

The present inventor has diligently investigated to achieve the above object and consequently found that a siloxane-branched polyether-modified silicone imparts excellent antifouling performance to a paint, and completed the present invention.

Specifically, the present invention is a paint additive comprising a siloxane-branched polyether-modified silicone shown by an average composition formula (1) R¹ₐR²_{b}R³_{c}SiO_{(4-a-b-c)/2} and having a weight-average molecular weight in a range of 500 to 100,000, wherein in the formula (1) each R is identical to or different from one another and represents an organic group selected from an alkyl group, an aryl group, and an aralkyl group having 1 to 30 carbon atoms, and an organic group shown by a general formula (2) —CₘH₂ₘ—O—(C₂H₄O)_{d}(C₃H₆O)ₑR⁴;
each R² represents a group shown by a general formula (3) —CₘH₂ₘ—O—(C₂H₄O)_{f}(C₃H₆O)_{g}—R⁵;
each R³ represents an organosiloxane shown by the following general formula (4)

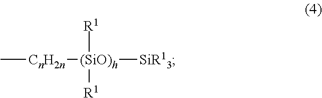

R⁴ represents a hydrocarbon group having 4 to 30 carbon atoms, or an organic group shown by R⁶—(CO)—;
R⁵ represents a hydrogen atom, a hydrocarbon group having 1 to 30 carbon atoms, or an organic group shown by R⁶—(CO)—;
R⁶ represents a hydrocarbon group having 1 to 30 carbon atoms;
R¹ in the general formula (4) is the same as R¹ in the formula (1);
“a”, “b”, and “c” respectively satisfy 1.0≤a≤2.5, 0.001≤b≤1.5, and 0.001≤c≤1.5;
“d” and “e” respectively represent integers satisfying 0≤d≤50 and 0≤e≤50;
“f” and “g” respectively represent integers satisfying 2≤f≤200, 0≤g≤200, and f+g being 3 to 200;
“m” represents an integer satisfying 0≤m≤10;
“h” represents an integer satisfying 0≤h≤500; and
“n” represents an integer satisfying 1≤n≤5.

Hereinafter, the present invention will be described in detail. However, the present invention is not limited thereto.

### <Paint Additive>

The siloxane-branched polyether-modified silicone contained in the paint additive of the present invention is shown by an average composition formula (1) R¹ₐR²_{b}R³_{c}SiO_{(4-a-b-c)/2}. In the formula (1), each R is identical to or different from one another and represents an organic group selected from an alkyl group, an aryl group, and an aralkyl group having 1 to 30 carbon atoms, and an organic group shown by a general formula (2) —CₘH₂ₘ—O—(C₂H₄O)_{d}(C₃H₆O)ₑR⁴. Each R² represents a group shown by a general formula (3) —CₘH₂ₘ—O—(C₂H₄O)_{f}(C₃H₆O)_{g}—R⁵. Each R³ represents an organosiloxane shown by the following general formula (4)

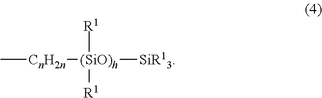

R⁴ represents a hydrocarbon group having 4 to 30 carbon atoms, or an organic group shown by R⁶—(CO)—. R⁵ represents a hydrogen atom, a hydrocarbon group having 1 to 30 carbon atoms, or an organic group shown by R⁶—(CO)—. R⁶ represents a hydrocarbon group having 1 to 30 carbon atoms. R in the general formula (4) is the same as R¹ in the formula (1). “a”, “b”, and “c” respectively satisfy 1.0≤a≤2.5, 0.001≤b≤1.5, and 0.001≤c≤1.5. “d” and “e” respectively represent integers satisfying 0≤d≤50 and 0≤e≤50. “f” and “g” respectively represent integers satisfying 2≤f≤200, 0≤g≤200, and f+g being 3 to 200. “m” represents an integer satisfying 0≤m≤10. “h” represents an integer satisfying 0≤h≤500. “n” represents an integer satisfying 1≤n≤5.

R¹ in the formulae is an alkyl group, an aryl group, and an aralkyl group having 1 to 30 carbon atoms. R is preferably an alkyl group, an aryl group, and an aralkyl group having 1 to 12 carbon atoms. R¹ is particularly preferably a methyl group, an ethyl group, a propyl group, a hexyl group, an octyl group, a dodecyl group, a phenyl group, and a 2-phenylpropyl group. Preferably, 80% or more of R's are methyl groups.

Alternatively, R¹ may be an alkoxy group, an ester group, an alkenyl ether residue, or an alkenyl ester residue shown by the general formula (2) —CₘH₂ₘ—O—(C₂H₄O)_{d}(C₃H₆O)ₑ—R⁴. Herein R⁴ in the formula (2) is a monovalent hydrocarbon group having 4 to 30 carbon atoms, or an organic group shown by R⁶—(CO)—, and preferably a monovalent hydrocarbon group having 4 to 10 carbon atoms, or an organic group shown by R⁶—(CO)— because of availability. R⁶ is a hydrocarbon group having 1 to 30 carbon atoms, and preferably a hydrocarbon group having 1 to 10 carbon atoms because of availability.

“d”, “e” and “m” are respectively integers satisfying 0≤d≤50, 0≤e≤50, and 0≤m≤10, and preferably integers satisfying 0≤d≤30, 0≤e≤30, and 2≤m≤5 because of availability. Incidentally, when the polyoxyalkylene moiety in the formula (2) is composed of both ethyleneoxide units and propyleneoxide units, the polyoxyalkylene moiety may be any of a block polymer and a random polymer of these two units.

R² is a group shown by the general formula (3) —CₘH₂ₘ—O—(C₂H₄O)_{f}(C₃H₆O)_{g}—R⁵. Herein R⁵ in the formula (3) represents a hydrogen atom, a monovalent hydrocarbon group having 1 to 30 carbon atoms, or an organic group shown by R⁶—(CO)—, and preferably a hydrocarbon group having 1 to 10 carbon atoms, a hydrogen atom, or an organic group shown by R⁶—(CO)— because of availability. R⁶ is as defined above.

“f” and “g” are respectively integers satisfying 2≤f≤200 and 0≤g≤200, and preferably integers satisfying 2≤f≤50 and 0≤g≤50 because of availability. Further, f+g is an integer satisfying 3 to 200, and preferably an integer satisfying 5 to 100. If f+g is smaller than 3, the antifouling property lowers. If f+g is larger than 200, the synthesis is hindered. “m” is as defined above.

Incidentally, like the formula (2), when the polyoxyalkylene moiety in the formula (3) is composed of both ethyleneoxide units and propyleneoxide units, the polyoxyalkylene moiety may be any of a block polymer and a random polymer of these two units.

R³ is an organosiloxane shown by the following general formula (4).

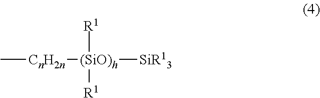

R¹ is as defined above. “h” is an integer satisfying 0≤h≤500, and preferably an integer satisfying 1 h 100. “n” is an integer satisfying 1≤n≤5, and preferably 2 because of availability. If “h” is larger than 500, the synthesis is hindered, and the compatibility with a resin is lowered as the paint composition in some cases.

“a”, “b”, and “c” respectively satisfy 1.0≤a≤2.5, preferably 1.0≤a≤2.3, 0.001≤b≤1.5, preferably 0.05≤b≤1.0, and 0.001≤c≤1.5, preferably 0.01≤c≤1.0. If “a” and “b” deviates from the range, the compatibility is unstable as the paint composition. Further, when “c” is below 0.001, the antifouling property as the paint composition decreases, and when more than 1.5, the compatibility is unstable as the paint composition.

Further, the siloxane-branched polyether-modified silicone shown by the formula (1) has a weight-average molecular weight of 500 to 100,000, preferably 1,000 to 80,000, and particularly preferably 1,500 to 40,000, in terms of polystyrene according to GPC. When the weight-average molecular weight is less than 500, the antifouling property lowers. When the weight-average molecular weight is 100,000 or more, the resulting silicone has such high viscosity that it is difficult to handle, and further the compatibility with a resin is lowered as the paint composition in some cases.

The siloxane-branched polyether-modified silicone contained in the inventive paint additive can be obtained by a known method. For example, as described in Patent Document 3 (JP 2001-039819 A), the siloxane-branched polyether-modified silicone can be easily synthesized by subjecting an organohydrogenpolysiloxane to addition reaction with an alkenyl group-containing organosiloxane and an alkenyl group-containing polyoxyalkylene compound in the presence of a platinum or rhodium catalyst.

Moreover, the inventive paint additive may be the siloxane-branched polyether-modified silicone only, or may further contain a solvent in addition to the siloxane-branched polyether-modified silicone. When the inventive paint additive contains a solvent and is added to a paint composition, homogenizing by stirring becomes easier. Further, the paint additive may contain other components as necessary.

As the solvent which may be blended to the inventive paint additive, for example, it is possible to use one explained in the description of the paint composition described below. Preferable ones are propylene glycol monomethyl ether acetate and butyl acetate. Furthermore, when the inventive paint additive contains a solvent, for example, the paint additive may be a 10 to 90% solution of the siloxane-branched polyether-modified silicone, preferably 10 to 50% solution, and particularly preferably 15 to 30% solution.

### <Paint Composition>

Furthermore, the present invention provides a paint composition containing the paint additive. The paint composition is used particularly for antifouling paint.

The addition amount of the siloxane-branched polyether-modified silicone (that is, the effective component contained in the inventive paint additive) is 0.01 to 10 parts by mass, preferably 0.1 to 5 parts by mass, of 100 parts by mass of the inventive paint composition. With these ranges of the addition amount, dirt prevention corresponding to the addition amount is surely obtained, which is cost effective.

The inventive paint composition preferably contains a resin. The resin is not particularly limited, and is selected from the group consisting of urethane resins, acrylic resins, amide resins, phenolic resins, epoxy resins, melamine resins, urea resins, alkyd resins, polyimide resins, polyalkylene resins, polyvinyl chloride, polystyrene, polyvinyl acetate, and alloys of the resins. The resin is preferably a urethane resin or an acrylic resin in view of the compatibility with the paint additive containing the siloxane-branched polyether-modified silicone.

The addition amount of the resin is 10 to 99.5 parts by mass, preferably 25 to 90 parts by mass, of 100 parts by mass of the inventive paint composition. With the resin content being 10 parts by mass or more, there is no fear of decrease of mechanical strength.

The inventive paint composition can be optionally blended with other well-known components in the industry as appropriate, such as a curing agent, a dilution solvent, a ultraviolet absorber, a polymerization initiator, a polymerization inhibitor, a neutralizing agent, a stabilizer (a light-resistant stabilizer, a weather-resistant stabilizer, a heat-resistant stabilizer), an antioxidant, a leveling agent, a defoaming agent, a viscosity adjuster, a precipitation-inhibitor, a pigment, a dye, a dispersant, an antistatic agent, an anti-fog agent, and a rubber.

Examples of the curing agent include aliphatic polyisocyanate (hexamethylene diisocyanate trimer) (DESMODUR N 3390 BA/SN manufactured by Covestro AG), etc. The amount of the curing agent is not particularly limited, and may be 1 to 30 parts by mass, preferably 3 to 15 parts by mass, of 100 parts by mass of the inventive paint composition.

Examples of the dilution solvent include propylene glycol monomethyl ether acetate, butyl acetate, ester, aliphatic hydrocarbon, aromatic hydrocarbon, ketone, and alcohol. Propylene glycol monomethyl ether acetate and butyl acetate are preferable. The amount of the dilution solvent is not particularly limited, and may be 10 to 90 parts by mass, preferably 20 to 70 parts by mass, of 100 parts by mass of the inventive paint composition.

The inventive paint composition has a viscosity (25° C., B-type viscometer) of, for example, 1 to 10,000 mPa·s, preferably 10 to 5,000 mPa·s, in consideration of the coatability, film thickness, etc.

### <Coating Layer>

Further, the present invention relates to a coating layer using the paint composition.

Various methods to be applied for typical paints are available as the coating method with the paint composition for obtaining the inventive coating layer. Specifically, examples thereof include spray coating, spin coating, roll coating, curtain coating, brushing, electrostatic coating, anionic and cationic electrodeposition coating, dipping, etc. In addition, the curing method after coating is not particularly limited and examples thereof include (heat) curing particularly at 0 to 200° C., more preferably 40 to 180° C.

Moreover, examples of base materials to which the coating layer is applied (materials to be coated) include: plastics such as polystyrene resins, acrylic resins, acrylonitrile-styrene-butadiene resins (ABS), polypropylene, ethylene-propylene resins, polycarbonate resins, Noryl resins, nylon resins, polyester resins, and blends (alloys) of these resins with, for example, polyolefins, fillers, and reinforcement materials, such as glasses and carbon fibers; thermosetting resins, such as epoxy resins, unsaturated polyester resins, and urethane resins; inorganic materials, such as glasses, mortars, asbestos-cement slates, and rocks; metals, such as iron (and alloys), copper (and alloys), aluminum (and alloys), and magnesium (and alloys); combustible materials, such as papers and vinyl fabrics; etc.

### EXAMPLE

Hereinafter, the present invention will be specifically described with reference to Examples and Comparative Examples. However, the present invention is not limited thereto. Incidentally, in a case where multiple repeating units, each of which is shown in the parentheses, are included in the structural formulae described below, these units are arranged at random.

### Synthesis Example 1

In a reactor, 250 g of organohydrogensiloxane shown by the following structural formula (I), 87 g of organosiloxane shown by the following structural formula (i), and 150 g of isopropyl alcohol were mixed, and 0.05 g of isopropyl alcohol solution of 3% by mass chloroplatinic acid was added. This mixture was allowed to react at 80° C. for 4 hour.

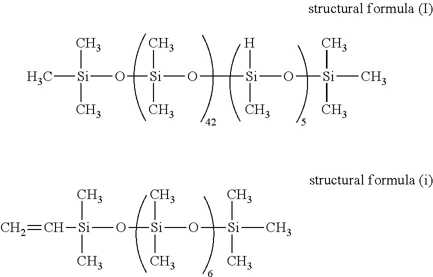

Then, 110 g of polyoxyalkylene compound of the following structural formula (a) was added, and the reaction was further continued for 3 hours.

CH₂═CHCH₂O(C₂H₄O)_{g}H structural formula (a)

After completion of the reaction, the obtained solution was heated under reduced pressure to distill the solvent to give a compound (A) of organopolysiloxane shown by the following structural formula in a yield of 95%. The weight-average molecular weight of the obtained compound (A) was 6,200.

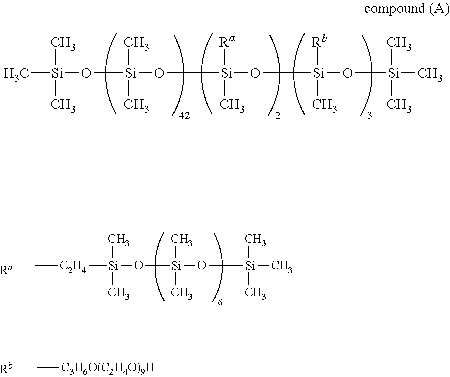

### Synthesis Example 2

A compound (B) of the following formula was obtained in a yield of 95% as in Synthesis Example 1, except that 250 g of organohydrogensiloxane shown by the following structural formula (II) was used instead of one in the structural formula (I) in Synthesis Example 1, the addition amount of organosiloxane of the structural formula (i) was changed to 62 g, and the addition amount of polyoxyalkylene compound of the structural formula (a) was changed to 125 g. The weight-average molecular weight of the obtained compound (B) was 8,500.

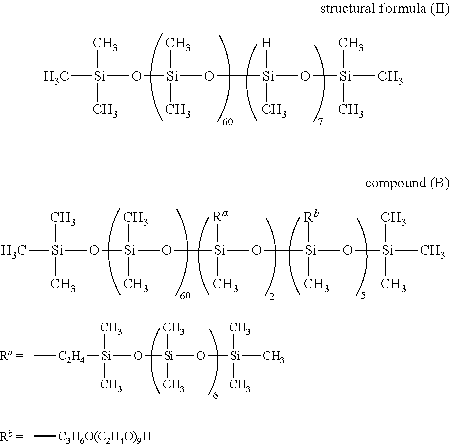

### Example 1

0.4 g of 25% propylene glycol monomethyl ether acetate solution of the compound (A) obtained in Synthesis Example 1 was added as the paint additive to 20 g of 60% hydroxy functional acrylic resin solution (MACRYNAL SM 510n/60LG manufactured by Allnex GMBH), 10 g of propylene glycol monomethyl ether acetate, and 10 g of butyl acetate. Then, 4.0 g of aliphatic polyisocyanate (hexamethylene diisocyanate trimer) (DESMODUR N 3390 BA/SN manufactured by Covestro AG) was further added as the curing agent, mixed by using a dispersion mixer until uniform to prepare a paint composition. After being left standing for 30 minutes, the obtained paint composition was coated on glass using an applicator so as to have the thickness of 30 μm, and heated and cured at 80° C. for 40 minutes to form a coating layer (1). The obtained coating layer (1) was subjected to various evaluations as follows.

### Defoaming Property

The paint composition was uniformly mixed by using a dispersion mixer and left standing for 10 minutes. Then, the state of the paint composition was observed.
◯: no foams.
Δ: a few fine foams.
x: a lot of foams.

### Leveling Property

The surface state of the coating layer on the glass was visually observed.
◯: smooth surface state.
Δ: fine craters in places on surface.
x: large craters and waves on surface.

### Antifouling Property

A line was drawn with a marker pen on the coating layer on the glass, and rubbed with tissue paper. The easiness for erasing the line was evaluated in this event.
◯: the line was easily erased.
Δ: the line was erased by repeatedly rubbing the layer with force.
x: the line was not erased.

### Example 2

A coating layer (2) was formed and the various properties thereof were evaluated as in Example 1, except that 25% propylene glycol monomethyl ether acetate solution of the compound (B) was used instead of 25% propylene glycol monomethyl ether acetate solution of the compound (A) in Example 1.

### Comparative Example 1

A coating layer (3) was formed and the various properties thereof were evaluated as in Example 1, except that the 25% propylene glycol monomethyl ether acetate solution of the compound (A) in Example 1 was not added.

### Comparative Example 2

A coating layer (4) was formed and the various properties thereof were evaluated as in Example 1, except that 25% propylene glycol monomethyl ether acetate solution of the compound (C) of the following formula (weight-average molecular weight: 6,100) was used instead of 25% propylene glycol monomethyl ether acetate solution of the compound (A) in Example 1.

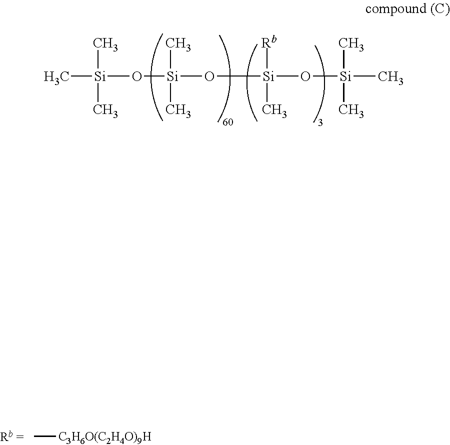

### Comparative Example 3

A coating layer (5) was formed and the various properties thereof were evaluated as in Example 1, except that 25% propylene glycol monomethyl ether acetate solution of the compound (D) of the following formula (weight-average molecular weight: 8,300) was used instead of 25% propylene glycol monomethyl ether acetate solution of the compound (A) in Example 1.

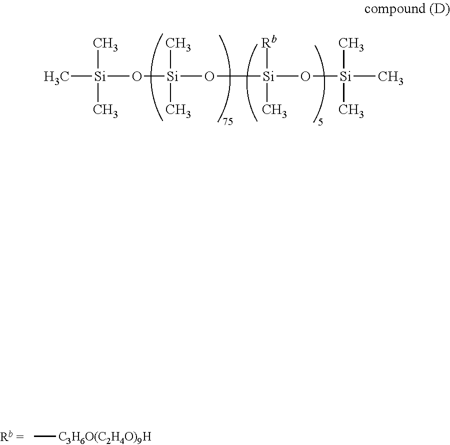

The following Table 1 shows the results of Examples 1 and 2, and Comparative Examples 1, 2, and 3.

TABLE 1

| | | | Comparative | Comparative | Comparative |
|---|---|---|---|---|---|
| | Example 1 | Example 2 | Example 1 | Example 2 | Example 3 |
| | Coating | Coating | Coating | Coating | Coating |
| | layer (1) | layer (2) | layer (3) | layer (4) | layer (5) |
| Defoaming | ∘ | ∘ | Δ | ∘ | ∘ |
| Property | | | | | |
| Leveling | ∘ | ∘ | x | ∘ | ∘ |
| Property | | | | | |
| Antifouling | ∘ | ∘ | x | x | Δ |
| Property | | | | | |

As shown in Table 1, it was revealed that the coating layers (1) and (2) formed from the paint compositions using the inventive paint additives exhibited excellent antifouling property without impairing defoaming property and leveling property.

On the other hand, Comparative Example 1 using the paint composition without the additive failed to obtain good results in all of defoaming property, leveling property and antifouling property. Further, in Comparative Examples 2 and 3, each coating layer was formed from the paint composition using the additive containing the polyether-modified silicone. However, because these additives did not have the structure of the general formula (4) unlike the inventive paint additives, the coating layers failed to obtain good results in antifouling property either.

It should be noted that the present invention is not limited to the above-described embodiments. The embodiments are just examples, and any embodiments that substantially have the same feature and demonstrate the same functions and effects as those in the technical concept disclosed in claims of the present invention are included in the technical scope of the present invention.

1. A paint additive comprising a siloxane-branched polyether-modified silicone shown by an average composition formula (1) R¹ₐR²_{b}R³_{c}SiO_{(4-a-b-c)/2} and having a weight-average molecular weight in a range of 500 to 100,000,
wherein in the formula (1) each R¹ is identical to or different from one another and represents an organic group selected from an alkyl group, an aryl group, and an aralkyl group having 1 to 30 carbon atoms, and an organic group shown by a general formula (2) —CₘH₂ₘ—O—(C₂H₄O)_{d}(C₃H₆O)ₑR⁴;
each R² represents a group shown by a general formula (3) —CₘH₂ₘ—O—(C₂H₄O)_{f}(C₃H₆O)_{g}—R⁵;
each R³ represents an organosiloxane shown by the following general formula (4) 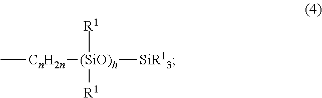
R⁴ represents a hydrocarbon group having 4 to 30 carbon atoms, or an organic group shown by R⁶—(CO)—;
R⁵ represents a hydrogen atom, a hydrocarbon group having 1 to 30 carbon atoms, or an organic group shown by R⁶—(CO)—;
R⁶ represents a hydrocarbon group having 1 to 30 carbon atoms;
R¹ in the general formula (4) is the same as R¹ in the formula (1);
“a”, “b”, and “c” respectively satisfy 1.0≤a≤2.5, 0.001≤b≤1.5, and 0.001≤c≤1.5;
“d” and “e” respectively represent integers satisfying 0≤d≤50 and 0≤e≤50;
“f” and “g” respectively represent integers satisfying 2≤f≤200, 0≤g≤200, and f+g being 3 to 200;
“m” represents an integer satisfying 0≤m≤10;
“h” represents an integer satisfying 0≤h≤500; and
“n” represents an integer satisfying 1≤n≤5.

2. The paint additive according to claim 1, further comprising a solvent.

3. A paint composition comprising the paint additive according to claim 1 or 2.

4. The paint composition according to claim 3, comprising a resin selected from the group consisting of urethane resins, acrylic resins, amide resins, phenolic resins, epoxy resins, melamine resins, urea resins, alkyd resins, polyimide resins, polyalkylene resins, polyvinyl chloride, polystyrene, polyvinyl acetate, and alloys of the resins.

5. The paint composition according to claim 4, wherein the resin is a urethane resin or an acrylic resin.

6. The paint composition according to any one of claims 3 to 5, the composition being used for antifouling paint.

7. A coating layer formed from the paint composition according to any one of claims 3 to 6.
